(19) United States
(12) Patent Application Publication
(10) Pub. No.: US 2018/0210293 A1
(43) Pub. Date: Jul. 26, 2018

(54) LIQUID CRYSTAL PANELS, LIQUID CRYSTAL ALIGNMENT METHODS THEREOF AND LIQUID CRYSTAL DISPLAYS

(71) Applicant: SHENZHEN CHINA STAR OPTOELECTRONICS TECHNOLOGY CO., LTD., Shenzhen, Guangdong (CN)

(72) Inventors: Yu ZHANG, Shenzhen, Guangdong (CN); Chung-ching HSIEH, Shenzhen, Guangdong (CN); Yanjun SONG, Shenzhen, Guangdong (CN)

(73) Assignee: Shenzhen China Star Optoelectronics Technology Co. , Ltd., Shenzhen, Guangdong (CN)

(21) Appl. No.: 15/328,899

(22) PCT Filed: Jan. 17, 2017
(86) PCT No.: PCT/CN2017/071332

§ 371 Date: Jan. 24, 2017

(30) Foreign Application Priority Data
Nov. 25, 2016 (CN) 201611064137.9

(51) Int. Cl. G02F 1/1337; G02F 1/1335; G02F 1/1333; G02F 1/1368; G02F 1/1362

(52) U.S. Cl. CPC G02F 1/133784; G02F 1/133514; G02F 1/133788; G02F 1/133512; G02F 2001/133749; G02F 1/1368; G02F 1/136286; G02F 1/136227; G02F 2201/121; G02F 1/133345

(57) ABSTRACT

The present disclosure discloses a liquid crystal display, including a liquid crystal panel and a backlight module opposite to the liquid crystal panel, wherein the liquid crystal panel includes: a color film substrate, an array substrate opposite to the color film substrate, a plurality of liquid crystal molecules sandwiched between the color film substrate, and the array substrate. The color film substrate includes at least one alignment electrode and a first alignment film layer disposed on the first alignment electrode, the array substrate includes a common electrode and a second alignment film layer disposed on the common electrode; conducting a mechanical rubbing process to the first alignment film layer and the second alignment film layer when performing an alignment process to the liquid crystal molecules, applying a voltage to the alignment electrode and the common electrode, and performing an UV exposure process to the liquid crystal molecules.

### BACKGROUND OF THE INVENTION

### 1. Field of the Invention

The present disclosure relates to liquid crystal display field, and more particularly to a liquid crystal panel, a liquid crystal display alignment method thereof ,and a liquid crystal display.

### 2. Discussion of the Related Art

With the evolution of optoelectronics and semiconductor technology, Flat Panel Display also develops vigorously. Among various flat displays, Liquid Crystal Display has been widely adopted due to attributes such as high space efficiency, low power consuming, no-radiation and low electromagnetic interference.

Usually, Liquid crystal display is of the backlight type, which includes a liquid crystal panel and a backlight module. The operation principle of the liquid crystal panel relates to configuring the liquid crystal molecules between two parallel glass substrates, i.e., the color film substrate (CF substrate) and the array substrate The two glass substrate charge the liquid crystal molecules to control the alignment of the liquid crystal molecules such that light beams from the backlight module are reflected to generate images.

LCD panel mainly include Twisted Nematic (TN) type, Super Twisted Nematic (STN) type, In-Plane Switching (IPS) type, Vertical Alignment (VA) type and Fringe-field Switching (FFS) type. The IPS mode is the mode using the electric field roughly paralleled with the substrate to drive liquid crystal molecules rotate along the inner surface of the substrate to response. Due to the greater viewing angle and high response speed, IPS mode has been widely adopted in TV display. However, FFS mode generates edge electric field though the electrodes between the pixel within the same surface to make the rotated-transformation of the liquid crystal molecules located between and on the top of the electrodes occur in the direction paralleled to the substrate, to rise the Light transmission efficiency of the liquid crystal layer in order to overcome the low Light transmission efficiency problem in the IPS mode, in the premise of wide viewing angle, to achieve the high light transmission efficiency.

However, in the alignment process of the current IPS type and FFS type liquid crystal panel, the predetermined pretilt angle cannot be 0 degree, the optical leakage may occur during the dark state.

### SUMMARY

To solve the technical problem mentioned above, the present disclosure provides a liquid crystal panel capable of controlling the predetermined pretilt angle of the liquid crystal molecules equal to be 0 degree and the liquid crystal alignment method thereto, and a liquid crystal display.

In one aspect, a liquid crystal panel includes: a color film substrate; an array substrate opposite to the color film substrate; a plurality of liquid crystal molecules sandwiched between the color film substrate and the array substrate; the color film substrate includes at least one alignment electrode and a first alignment film layer disposed on the alignment electrode, the array substrate includes a common electrode and a second alignment film layer disposed on the common electrode; conducting a mechanical rubbing process to the first alignment film layer and the second alignment film layer when performing an alignment process to the liquid crystal molecules, applying a voltage to the alignment electrode and the common electrode, and performing an ultraviolet (UV) exposure process to the liquid crystal molecules to provide a vertical electric field between the color film substrate and the array substrate such that a predetermined pretilt angle of the liquid crystal molecules equal to 0 degree.

Wherein the color film substrate includes: a first substrate, a black matrix, a plurality of color photo-resistor blocks, and a first insulation layer; the black matrix is disposed on the substrate and a plurality of first pixel areas are defined, the color photo-resistor blocks block are disposed on the substrate, and each of the color photo-resistor blocks is disposed within the corresponding first pixel area, the first insulation layer is disposed on the black matrix and the color photo-resistor blocks, and the alignment electrode is disposed on the first insulation layer.

Wherein the array substrate includes: a second substrate, a plurality of scanning lines and a plurality of data lines disposed on the second substrate, a plurality of switch units, an insulation protection layer, and at least one pixel electrode, the scanning lines and the data lines intersect with each other to define a plurality of second pixel areas, and the scanning lines and the data lines are insulated from each other, each of the switch units is disposed within the corresponding second pixel area, the insulation protection layer is disposed on the switch units, the pixel electrode and the common electrode are independently disposed on the insulation protection layer, the second alignment film layer is disposed on the pixel electrode, and the common electrode and the insulation protection layer.

Wherein the switch unit includes: a gate formed on the second substrate; a gate insulation layer formed on the gate and the second substrate; a semiconductor layer corresponds to a top of the gate, and is formed on the gate insulation layer; a source and a drain formed on the semiconductor layer and the gate insulation layer, the insulation protection layer formed on the source, the drain, the semiconductor layer and the gate insulation layer, a through hole is formed on the insulation protection layer, and the through hole corresponds to the drain, and the pixel electrode contacts with the drain through the through hole.

Wherein the array substrate includes: a second substrate, a plurality of scanning lines and a plurality of data lines disposed on the second substrate, a plurality of switch units, a second insulation layer, an insulation protection layer, and at least one pixel electrode; the scanning lines and the data lines intersect with each other to define a plurality of second pixel areas, and the scanning lines and the data lines are insulated from each other, each of the switch units is disposed within the corresponding second pixel area, the insulation protection layer is disposed on the switch unit, and the common electrode is disposed on the insulation protection layer, the second insulation layer is disposed on the common electrode and the insulation protection layer, the pixel electrode is disposed on the second insulation layer, and the second alignment film layer disposed on the pixel electrode and second insulation layer.

Wherein the switch unit includes: a gate formed on the second substrate, a gate insulation layer formed on the gate and the second substrate; a semiconductor layer corresponds to a top of the gate, and is formed on the gate insulation layer; a source and a drain formed on the semiconductor layer and the gate insulation layer, the insulation protection layer formed on the source, the drain, the semiconductor layer and the gate insulation layer, a through hole is formed on the insulation protection layer, and the second insulation layer corresponds to the drain, and the pixel electrode contacts with the drain through the through hole.

Wherein the switch unit includes: a gate formed on the second substrate; a gate insulation layer formed on the gate and the second substrate; a semiconductor layer corresponds to a top of the gate and is formed on the gate insulation layer; a source and a drain formed on the semiconductor layer and the gate insulation layer, the insulation protection layer formed on the source, the drain, the semiconductor layer and the gate insulation layer, a through hole is formed on the insulation protection layer, and the second insulation layer corresponds to the drain, and the pixel electrode contacts with the drain through the through hole.

Wherein the liquid crystal molecules are doped with reactive monomers.

In another aspect, a liquid crystal alignment method for the above liquid crystal panel includes: conducting a mechanical rubbing process to the first alignment film layer and the second alignment film layer; applying a voltage to the alignment electrode and the common electrode, and performing an UV exposure process to the liquid crystal molecules to provide a vertical electric field between the color film substrate and the array substrate such that a predetermined pretilt angle of the liquid crystal molecules equal to 0 degree.

In another aspect, a liquid crystal display includes a liquid crystal panel and a backlight module opposite to the liquid crystal panel.

In view of the above, the liquid crystal panel and the liquid crystal alignment method are capable of controlling the predetermined pretilt angle of the liquid crystal molecules equal to be 0 degree such that optical leakage during the dark state may be avoided.

### BRIEF DESCRIPTION OF THE DRAWINGS

The above and other aspects, features and advantages of the embodiments of the present disclosure will become more apparent from the following description with the accompanying drawings, in the drawings:

FIG. 1 is the top view of a color film substrate in accordance with one embodiment of the claimed invention.

FIG. 2 is the side view of the color film substrate in accordance with one embodiment of the claimed invention.

FIG. 3 is the top view of an array substrate in accordance with one embodiment of the claimed invention.

FIG. 4 is the side view of the array substrate in accordance with one embodiment of the claimed invention.

FIG. 5 is the top view of the array substrate in accordance with the other embodiment of the present disclosure.

FIG. 6 is the side view of the array substrate in accordance with the other embodiment of the present disclosure.

FIG. 7 is the schematic view of the liquid crystal panel formed by the color film substrate shown in FIG. 2 and the array substrate opposite to the color film substrate shown in FIG. 4.

FIG. 8 is the schematic view of the liquid crystal panel formed by color film substrate shown in FIG. 2 and the array substrate opposite to the color film substrate shown in FIG. 6.

### DETAILED DESCRIPTION OF THE EMBODIMENTS

Following embodiments of the invention will now be described in detail hereinafter with reference to the accompanying drawings. However, there are plenty of forms to implement the present disclosure, and the invention should not be construed as limitation to the embodiments. Rather, these embodiments are provided to explain the principles of the invention and its practical application, thereby enabling other person skilled in the art to understand each of the embodiments in the invention and various modifications being suitable for the particular application.

In the drawings, the thicknesses of layers and regions may be exaggerated for clarity. It should be noted that the relational terms herein, such as an element is disposed “above” or “on” an other element, it may be disposed directly on the other, or may exist a still other element between.

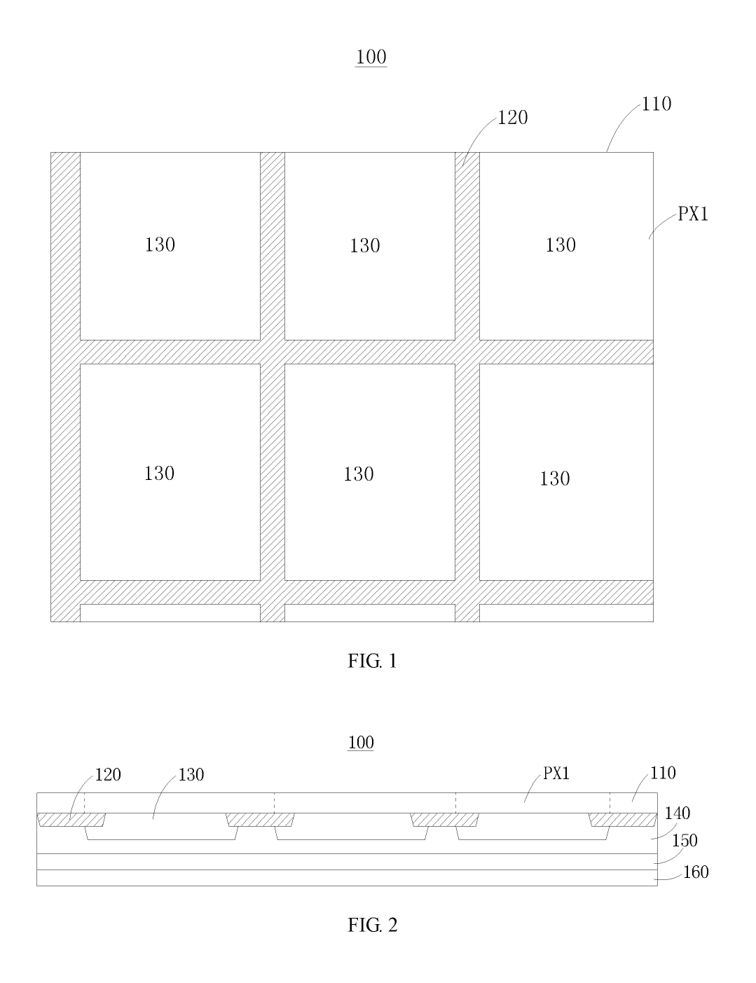

FIG. 1 is the top view of a color film substrate in accordance with one embodiment of the claimed invention. FIG. 2 is the side view of the color film substrate in accordance with the embodiment of the present disclosure. In FIG. 1, to show the displacement of a black matrix 120 and a plurality of color photo-resistor blocks 130 conveniently, a first insulation layer 140, a plurality of alignment electrode 150 and a first alignment film layer 160 are not shown.

Referring to FIG. 1 and FIG. 2, in accordance with the embodiment of the present disclosure, a color film substrate 100 includes: a first substrate 110, the black matrix 120, the color photo-resistor blocks 130, the first insulation layer 140, the alignment electrodes 150 and the first alignment film layer 160.

The first substrate 110 is, for example, a transparent glass substrate or a plastic substrate, but it is not limited in the present disclosure.

The black matrix 120 is disposed on the first substrate 110 and a plurality of first pixel areas PX1 is defined. The first pixel areas PX1 are arrange in array.

The color photo-resistor blocks 130 are disposed on the first substrate 110, and each of the color photo-resistor blocks 130 is located within the corresponding first pixel areas PX1. In this embodiment, the color photo-resistor blocks 130 are red photo-resistor blocks, green photo-resistor blocks, blue photo-resistor blocks, but they are not limited in the present disclosure. For example, the color photo-resistor blocks 130 may be a photo-resistor in any suitable color (such as white color). The color photo-resistor blocks 130 include red photo-resistor blocks, green photo-resistor blocks, blue photo-resistor blocks. In this embodiment, the red photo-resistor blocks, the green photo-resistor blocks, the blue photo-resistor blocks may be regarded as a photo-resistor unit arranged in array.

The first insulation layer 140 is disposed on the black matrix 120 and the color photo-resistor blocks 130. The first insulation layer 140 can be made of inorganic insulating materials or organic insulating materials.

The alignment electrode 150 is disposed on the first insulation layer 140. As a kind of embodiments in this invention, the alignment electrode 150 may be formed by at least one of indium tin oxide, indium zinc oxide, aluminum tin oxide, aluminum zinc oxide, and indium germanium zinc oxide, but it's not limited in the present disclosure.

The first alignment film layer 160 is disposed on the alignment electrode 150. As a kind of embodiments in this invention, the alignment electrode 150 is formed by polyimide (PI), but it's not limited in the present disclosure.

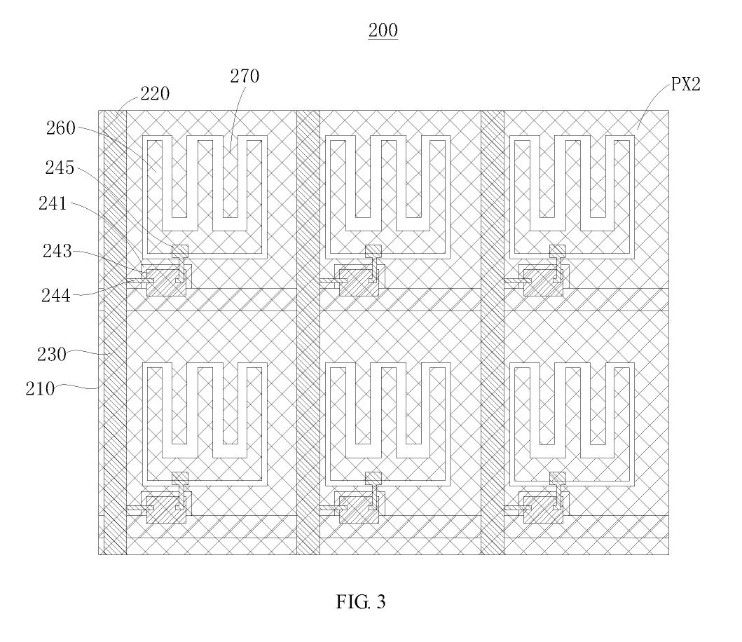

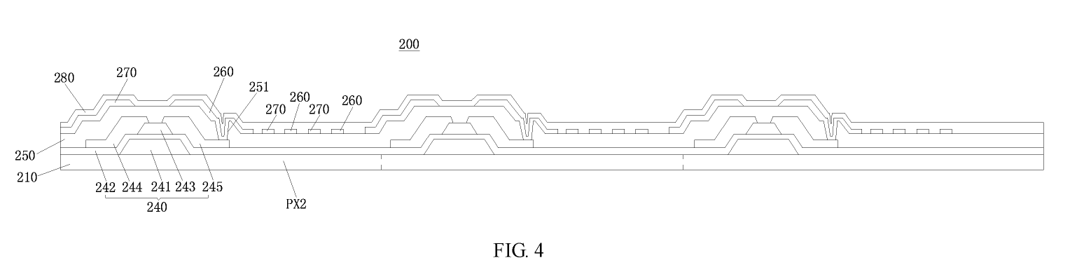

FIG. 3 is the top view of a array substrate in accordance with the embodiment of the present disclosure. FIG. 4 is the side view of the array substrate in accordance with the embodiment of the present disclosure. For the convenience of showing other elements, a gate insulation layer 242 and a second alignment film layer 280 are not shown in FIG. 3, a plurality of scanning line 220 and a plurality of data lines 230 are not shown in FIG. 4.

Referring to FIGS. 3 and 4, the array substrate 200, in accordance with the embodiment of the present disclosure, is a IPS type array substrate, which includes: a second substrate 210, the scanning line 220, the data lines 230, a plurality of switch units 240, an insulation protection layer 250, at least one pixel electrode 260, a common electrode 270 and a second alignment film layer 280.

The second substrate 210 is, for example, a transparent glass substrate or a plastic substrate, but it is not limited in the present disclosure. The scanning lines 220 and the data lines 230 intersect with each other to define a plurality of second pixel areas PX2, and the scanning lines 220 and the data lines 230 are insulated from each other. After the array substrate 200 is assembled opposite to the color film substrate 100, the second pixel areas PX2 and the first pixel areas PX1 are aligned respectively.

Each of the switch units 240 is disposed within the corresponding second pixel area PX2. As a kind of embodiments in this invention, the switch units 240 include: a gate 241 formed on the second substrate 210, a gate insulation layer 242 formed on the gate 241 and the second substrate 210, a semiconductor layer 243 (also called source layer) corresponds to a top of the gate 241, and is formed on the gate insulation layer 242, a source 244 and a drain 245 formed on the semiconductor layer 242 wherein the source 244 and the drain 245 contact with both ends of the semiconductor layer 243.

The insulation protection layer 250 are formed on the source 244, the drain 245, the semiconductor layer 243 and the gate insulation layer 242. A through hole 251 is formed on the insulation protection layer 250, and the through hole 251 corresponds to a top of the drain 245.

The pixel electrode 260 and the common electrode 270 are formed on the insulation protection layer 250, wherein the pixel electrode 260 contacts with the drain 245 through the through hole 251.

The pixel electrode 260 and the common electrode 270 are obtained via pattering a same conductive and transparent layer, wherein the pixel electrode 260 and the common electrode 270 are independent and are insulated from each other. The pixel electrodes 260 within each of the second pixel areas PX2 are integrally formed, and the pixel electrodes 260 within different second pixel areas PX2 are independent and insulated from each other. With respect to the whole array substrate, the common electrode 270 is integrated formed.

In addition, the conductive transparent layer is made of at least one of indium tin oxide, indium zinc oxide, aluminum tin oxide, aluminum zinc oxide, and indium germanium zinc oxide, but is not limited in the present disclosure.

The second alignment film layer 280 is formed on the pixel electrode 260, the common electrode 270, and the insulation protection layer 250. In one embodiment, the second alignment film layer 280 is formed by polyimide (PI), but is not limited to the above.

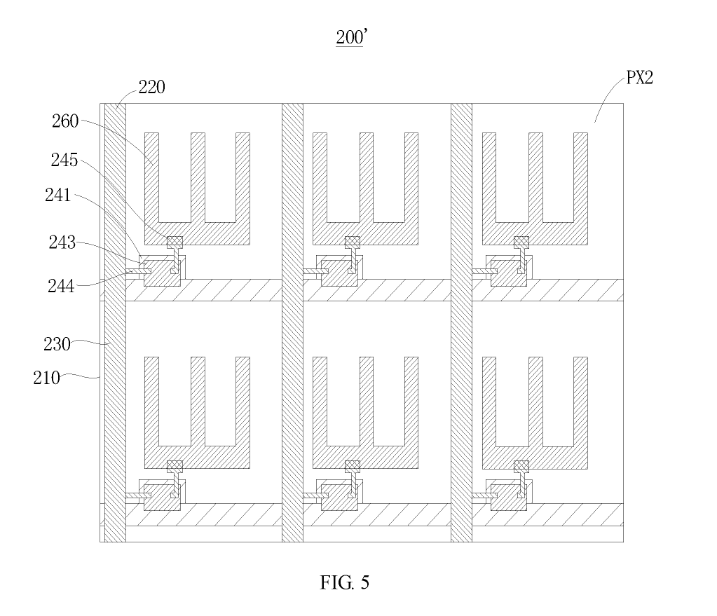

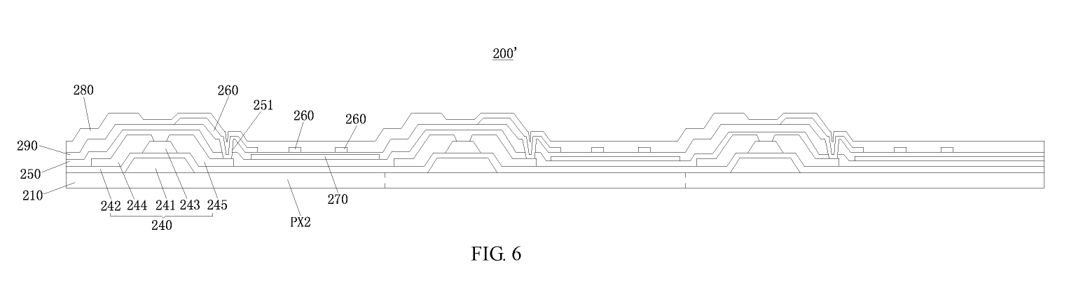

FIG. 5 is the top view of the array substrate 200 in accordance with one embodiment. FIG. 6 is the side view of the array substrate 200 in accordance with another embodiment. For convenience, the gate insulation layer 242, the second alignment film layer 280, a second insulation layer 290 and the common electrode 270 are not shown in FIG. 5, the scanning lines 220 and data lines 230 are not shown in FIG. 6.

Referring to FIGS. 5 and 6, the array substrate 200′ is a FFS type array substrate which is different from the array substrate 200 shown in FIGS. 3 and 4. The difference between the array substrate 200′ and the array substrate 200 shown in FIGS. 3 and 4 resides in that the pixel electrode 260 and the common electrode 270 are not on the same plane.

In particular, the array substrate 200′ further includes the second insulation layer 290. The difference between the array substrate 200′ and the array substrate 200 in FIGS. 3 and 4 resides in that the common electrode 270 is formed on the insulation protection layer 250, wherein there is no common electrode 270 is configured on a top of the corresponding drain 245. However, the common electrode 270 is integrally formed over the entire array substrate 200′.

The second insulation layer 290 is formed on the common electrode 270 and the insulation protection layer 250. The second insulation layer 290 may be made of inorganic insulating materials or organic insulating materials.

The pixel electrode 260 is formed on the second insulation layer 290, wherein the pixel electrode 260 contacts with the drain 245 through the through hole 251.

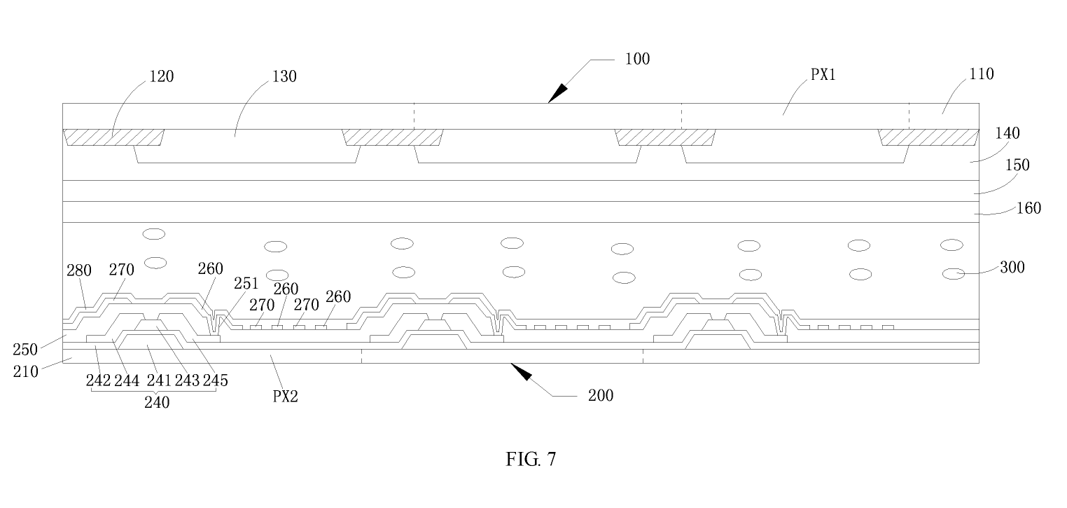

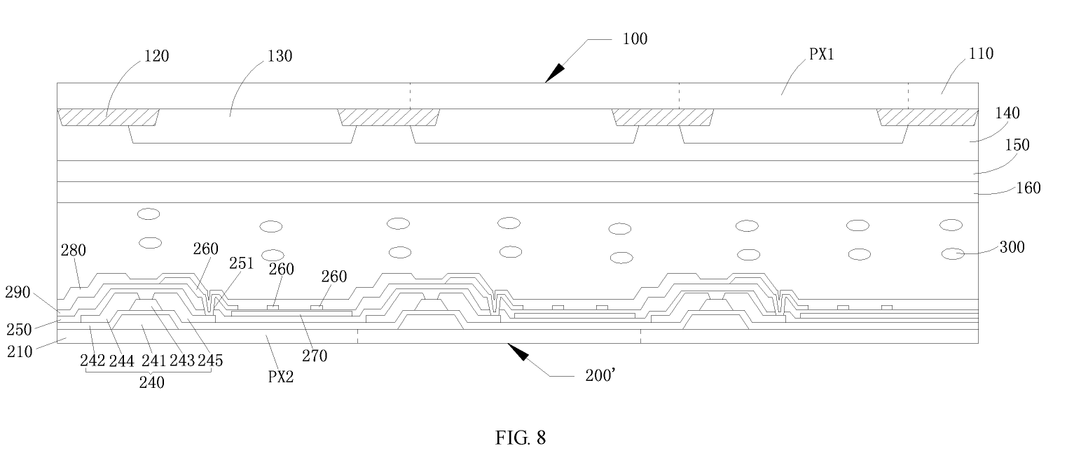

FIG. 7 is the structural schematic diagram of the liquid crystal panel formed by the color film substrate 100 shown in FIG. 2 and the array substrate 200 opposite to the color film substrate shown in FIG. 4. FIG. 8 is the structural schematic diagram of the liquid crystal panel formed by the color film substrate 100 shown in FIG. 2 and the array substrate 200 opposite to the color film substrate 100 shown in FIG. 6.

Referring to FIG. 7, the color film substrate 100 is disposed on the opposite side of the array substrate 200, a plurality of liquid crystal molecules 300 are stuffed between the color film substrate 100 and the array substrate 200.

Referring to FIG. 8, the color film substrate 100 is disposed on the opposite side of the array substrate 200′, the liquid crystal molecules 300 are stuffed between the color film substrate 100 and the array substrate 200′.

When performing an alignment process to the liquid crystal molecules 300, the liquid crystal alignment method for the liquid crystal panel including:

First, conducting a mechanical rubbing process to the first alignment film layer 160 and the second alignment film layer 280. Here, a rubbing process normally conducted to an alignment film layer in IPS type can be used.

Then, applying a voltage to the alignment electrode 150 and the common electrode 270, and perform an UV exposure process to the liquid crystal molecules 300 to provide a vertical electric field between the color film substrate 100 and the array substrate 200 or 200′ such that a predetermined pretile angle of the liquid crystal molecules 300 equal to 0 degree.

In this embodiment, the liquid crystal molecules 300 is doped with reactive monomers. When applying a voltage and performing the UV exposure process, reactive monomers may generate a separation phenomenon with the liquid crystal molecules 300, such that a polymer may be formed on the alignment film layer. The polymer may have the predetermined pretile angle through an interaction with the liquid crystal molecules 300.

As above, in accordance with the embodiment of the invention, the present disclosure may cause the predetermined pretile angle of the liquid crystal molecules equal to 0 degree in order to prevent light leakage in IPS type and FFS type liquid crystal display during the dark state.

Although the present disclosure has been explained referring to the specific embodiment, the person skilled in the art should understand: without departing from the spirit and scope of the invention as defined by the appended claims and their equivalents, various changes in form and detail may be made therein.

What is claimed is:

1. A liquid crystal panel, comprising:
a color film substrate;
an array substrate opposite to the color film substrate;
a plurality of liquid crystal molecules sandwiched between the color film substrate and the array substrate;
the color film substrate comprises at least one alignment electrode and a first alignment film layer disposed on the alignment electrode, the array substrate comprises a common electrode and a second alignment film layer disposed on the common electrode;
conducting a mechanical rubbing process to the first alignment film layer and the second alignment film layer when performing an alignment process to the liquid crystal molecules, applying a voltage to the alignment electrode and the common electrode, and performing an ultraviolet (UV) exposure process to the liquid crystal molecules to provide a vertical electric field between the color film substrate and the array substrate such that a predetermined pretilt angle of the liquid crystal molecules equal to 0 degree.

2. The liquid crystal panel according to claim 1, wherein the color film substrate comprises:
a first substrate, a black matrix, a plurality of color photo-resistor blocks, and a first insulation layer;
the black matrix is disposed on the substrate and a plurality of first pixel areas are defined, the color photo-resistor blocks block are disposed on the substrate, and each of the color photo-resistor blocks is disposed within the corresponding first pixel area, the first insulation layer is disposed on the black matrix and the color photo-resistor blocks, and the alignment electrode is disposed on the first insulation layer.

3. The liquid crystal panel according to claim 1, wherein the array substrate comprises:
a second substrate, a plurality of scanning lines and a plurality of data lines disposed on the second substrate, a plurality of switch units, an insulation protection layer, and at least one pixel electrode, the scanning lines and the data lines intersect with each other to define a plurality of second pixel areas, and the scanning lines and the data lines are insulated from each other, each of the switch units is disposed within the corresponding second pixel area, the insulation protection layer is disposed on the switch units, the pixel electrode and the common electrode are independently disposed on the insulation protection layer, the second alignment film layer is disposed on the pixel electrode, and the common electrode and the insulation protection layer.

4. The liquid crystal panel according to claim 2, wherein the array substrate comprises:
a second substrate, a plurality of scanning lines and a plurality of data lines disposed on the second substrate, a plurality of switch unit, an insulation protection layer, and at least one pixel electrode;
the scanning lines and the data lines intersect with each other to define a plurality of second pixel areas, and the scanning lines and the data lines are insulated from each other, each of the switch units is disposed within the corresponding second pixel area, the insulation protection layer is disposed on the switch units, the pixel electrode and the common electrode are independently disposed on the insulation protection layer, and the second alignment film layer is disposed on the pixel electrode, the common electrode and the insulation protection layer.

5. The liquid crystal panel according to claim 3, wherein the switch unit comprises:
a gate formed on the second substrate;
a gate insulation layer formed on the gate and the second substrate;
a semiconductor layer corresponds to a top of the gate, and is formed on the gate insulation layer;
a source and a drain formed on the semiconductor layer and the gate insulation layer, the insulation protection layer formed on the source, the drain, the semiconductor layer and the gate insulation layer, a through hole is formed on the insulation protection layer, and the through hole corresponds to the drain, and the pixel electrode contacts with the drain through the through hole.

6. The liquid crystal panel according to claim 4, wherein the switch unit comprises:
a gate formed on the second substrate;
a gate insulation layer formed on the gate and the second substrate;
a semiconductor layer corresponds to a top of the gate, and is formed on the gate insulation layer;
a source and a drain formed on the semiconductor layer and the gate insulation layer, the insulation protection layer formed on the source, the drain, the semiconductor layer and the gate insulation layer, a through hole is formed on the insulation protection layer, and the through hole corresponds to the drain, and the pixel electrode contacts with the drain through the via hole.

7. The liquid crystal panel according to claim 1, wherein the array substrate comprises:
a second substrate, a plurality of scanning lines and a plurality of data lines disposed on the second substrate, a plurality of switch units, a second insulation layer, an insulation protection layer, and at least one pixel electrode;
the scanning lines and the data lines intersect with each other to define a plurality of second pixel areas, and the scanning lines and the data lines are insulated from each other, each of the switch units is disposed within the corresponding second pixel area, the insulation protection layer is disposed on the switch unit, and the common electrode is disposed on the insulation protection layer, the second insulation layer is disposed on the common electrode and the insulation protection layer, the pixel electrode is disposed on the second insulation layer, and the second alignment film layer disposed on the pixel electrode and second insulation layer.

8. The liquid crystal panel according to claim 2, wherein the array substrate comprises:
a second substrate, a plurality of scanning lines and a plurality of data lines disposed on the second substrate, a plurality of switch unit, a second insulation layer, an insulation protection layer, and at least one pixel electrode, the scanning lines and the data lines intersect with each other to define a plurality of second pixel areas, and the scanning lines and the data lines are insulated from each other, each of the switch units is disposed within the corresponding second pixel area, the insulation protection layer is disposed on the switch unit, the common electrode is disposed on the insulation protection layer, the second insulation layer is disposed on the common electrode and the insulation protection layer, the pixel electrode is disposed on the second insulation layer, and the second alignment film layer disposed on the pixel electrode and second insulation layer.

9. The liquid crystal panel according to claim 7, wherein the switch unit comprises:
a gate formed on the second substrate, a gate insulation layer formed on the gate and the second substrate, a semiconductor layer corresponds to a top of the gate, and is formed on the gate insulation layer;
a source and a drain formed on the semiconductor layer and the gate insulation layer, the insulation protection layer formed on the source, the drain, the semiconductor layer and the gate insulation layer, a through hole is formed on the insulation protection layer, and the second insulation layer corresponds to the drain, and the pixel electrode contacts with the drain through the through hole.

10. The liquid crystal panel according to claim 8, wherein the switch unit comprises:
a gate formed on the second substrate;
a gate insulation layer formed on the gate and the second substrate;
a semiconductor layer corresponds to a top of the gate and is formed on the gate insulation layer;
a source and a drain formed on the semiconductor layer and the gate insulation layer, the insulation protection layer formed on the source, the drain, the semiconductor layer and the gate insulation layer, a through hole is formed on the insulation protection layer, and the second insulation layer corresponds to the drain, and the pixel electrode contacts with the drain through the through hole.

11. The liquid crystal panel according to claim 1, wherein the liquid crystal molecules are doped with reactive monomers.

12. A liquid crystal alignment method for the liquid crystal panel as claimed in claim 1, comprising:
conducting a mechanical rubbing process to the first alignment film layer and the second alignment film layer;
applying a voltage to the alignment electrode and the common electrode, and performing an UV exposure process to the liquid crystal molecules to provide a vertical electric field between the color film substrate and the array substrate such that a predetermined pretilt angle of the liquid crystal molecules equal to 0 degree.

13. A liquid crystal display, comprising:
a liquid crystal panel and a backlight module opposite to the liquid crystal panel, wherein the liquid crystal panel comprises a color film substrate, an array substrate opposite to the color film substrate, and a plurality of liquid crystal molecules sandwiched between the color film substrate and the array substrate;
the color film substrate comprises at least one alignment electrode and a first alignment film layer disposed on the first alignment electrode, the array substrate comprises a common electrode and a second alignment film layer disposed on the common electrode;
conducting a mechanical rubbing process to the first alignment film layer and the second alignment film layer when performing an alignment process to the liquid crystal molecules, applying a voltage to the alignment electrode and the common electrode, and performing an UV exposure process to the liquid crystal molecules to provide a vertical electric field between the color film substrate and the array substrate such that a predetermined pretilt angle of the liquid crystal molecules equal to 0 degree.
